(19) United States
(12) Patent Application Publication
(10) Pub. No.: US 2026/0270199 A1
(43) Pub. Date: Sep. 10, 2026

(54) Implementing Class-Based Forwarding (CBF) with Parent and Child Forwarding Equivalence Classes (FECs)

(71) Applicant: Arista Networks, Inc., Santa Clara, CA (US)

(72) Inventors: Aftab NARSIMHAN, Vancouver (CA); Mayukh SAUBHASIK, Richmond (CA); Vahab AKBARZADEH, Langley (CA); Kaushik Kumar RAM, San Jose, CA (US)

(21) Appl. No.: 19/073,565

(22) Filed: Mar. 7, 2025

(51) Int. Cl. H04L 45/00; H04L 45/745

(52) U.S. Cl. CPC H04L 45/54; H04L 45/74591

(57) ABSTRACT

Techniques for implementing class-based forwarding (CBF) in a network device that has configured thereon one or more parent forwarding equivalence classes (FECs) and child FECs are provided. In certain embodiments, these techniques can ensure that any CBF override rule configured on the network device that overrides a child FEC is also enforced in the context of the parent FEC(s) of that child FEC, thereby avoiding incorrect forwarding behavior.

### BACKGROUND

A forwarding equivalence class (FEC) is a classification assigned to a group of network packets that indicates the packets should be forwarded in the same way (e.g., sent to the same next hop) by a network device like a switch or router. Class-based forwarding (CBF) is a feature that allows the assigned FEC of a network packet to be overridden (or in other words, switched to a different FEC) based on one or more criteria, such as the traffic class to which the packet belongs.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example network device in accordance with certain embodiments of the present disclosure.

FIG. 2 depicts another example network device in accordance with certain embodiments of the present disclosure.

FIGS. 3A and 3B depicts a first workflow in accordance with certain embodiments of the present disclosure.

FIG. 4 depicts a second workflow in accordance with certain embodiments of the present disclosure.

FIG. 5 depicts a third workflow in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for implementing CBF in a network device that has configured thereon one or more parent FECs. A parent FEC is a type of FEC that aggregates/contains multiple other FECs, referred to as child FECs. For example, a parent FEC may correspond to an Equal Cost Multi-Path (ECMP) routing group and each child FEC of the parent FEC may correspond to a member of the ECMP routing group.

In certain embodiments, the techniques described herein can ensure that any CBF override rule configured on the network device that overrides a child FEC (referred to as a child FEC CBF override rule) is also enforced in the context of the parent FEC(s) of that child FEC. This prevents the network device from making incorrect forwarding decisions with respect to network packets that are assigned the parent FEC(s).

### 1. Example Network Device

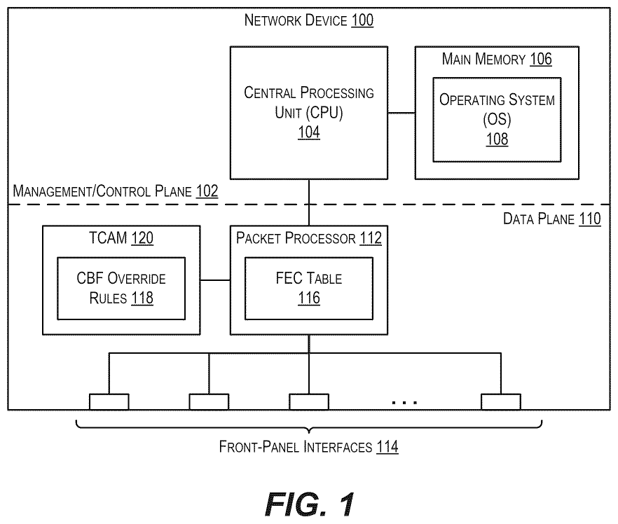

FIG. 1 is a simplified block diagram of a network device (e.g., switch or router) 100 in which the techniques of the present disclosure may be implemented. As shown, network device 100 comprises a management/control plane 102 that includes a central processing unit (CPU) 104 and a main memory (e.g., random-access memory or RAM) 106. CPU 104 is a general-purpose processor that is responsible for managing the configuration/operation of network device 100 and controlling the device's understanding of the network in which it resides. CPU 104 carries out these functions under the direction of an operating system (OS) 108 that runs on CPU 104 from main memory 106.

Network device 100 also comprises a data plane 110 including a packet processor 112 and a set of front-panel interfaces (i.e., ports) 114. Packet processor 112 is typically an integrated circuit, such as an application-specific integrated circuit (ASIC) or a field-programmable gate array (FPGA), that is responsible for performing line-speed processing of network traffic (i.e., packets) that pass through network device 100 via front-panel interfaces 114. This line-speed processing includes, among other things, Layer 2 and Layer 3 forwarding of incoming (i.e., ingress) packets.

### 1.1 Forwarding Equivalence Classes (FECs)

Generally speaking, packet processor 112 forwards an ingress packet by assigning to the packet a FEC from among a plurality of FECs held in a FEC table 116, where the assigned FEC is mapped to the packet's destination address. Each of these FECs can be understood as a classification that is associated with forwarding information indicating how packets belonging to the classification should be forwarded. For example, an FEC may be associated with a next hop, a next hop group (NHG), a Multiprotocol Label Switching (MPLS) tunnel, or the like. Upon assigning to the ingress packet a particular FEC in FEC table 116 based on the packet's destination address, packet processor 112 determines one or more egress interfaces for the packet in accordance with the assigned FEC and sends out the packet on those egress interface(s), thereby forwarding the packet towards its destination.

In some scenarios, there may be multiple FECs in FEC table 116 that are mapped to (and thus can be used to reach) a destination address D, where the multiple FECs have the same or different transmission costs associated with them. For instance, the multiple FECs may be members of an ECMP routing group or an unequal-cost multi-path (UCMP) routing group. In such scenarios, network device 100 will typically have configured within FEC table 116 a parent FEC that is mapped to destination address D and that includes/contains the multiple FECs as child FECs. This allows packet processor 112 to assign the parent FEC to an ingress packet that is destined for D and then select one of the child FECs of the assigned parent FEC (usually in a random manner) for determining how to forward the packet.

For example, the following listing presents two sample parent FECs named parentFecA and parentFecB respectively:
parentFecA=[childFecA, childFecB]
parentFecB=[childFecA, childFecC]

### Listing 1

As shown, parentFecA comprises two child FECs (childFecA and childFecB) and parentFecB comprises two child FECs (childFecA and childFecC). Each of these child FECs is associated with forwarding information (e.g., one or more next hops, an MPLS tunnel, etc.) and, in some cases, may be a parent FEC itself (which means that it contains one or more nested child FECs). At the time packet processor 112 receives an ingress packet destined for a destination address that is mapped to parentFecA, the packet processor will assign parentFecA to the packet and forward the packet in accordance with one of the child FECs of parentFecA (i.e., childFecA or childFecB). Similarly, at the time packet processor 112 receives an ingress packet destined for a destination address that is mapped to parentFecB, the packet processor will assign parentFecB to the packet and forward the packet in accordance with one of the child FECs of parentFecB (i.e., childFecA or childFecC).

### 1.2 Class-Based Forwarding (CBF)

CBF is a feature that enables packet processor 112 to override (i.e., replace) the assigned FEC of an ingress packet with another, alternative FEC. This is achieved by (1) configuring a set of CBF override rules 118 in a ternary content-addressable memory (TCAM) 120 of packet processor 112, where each rule specifies a FEC that is overridden by the rule (referred to as the overridden FEC), one or more override criteria for applying the rule, and a FEC that overrides the overridden FEC (referred to as the overriding FEC), and (2) enforcing the configured rules against ingress traffic. Typically, the one or more criteria specified in each CBF override rule pertains to the traffic class of an ingress packet, as identified by the Differentiated Services Code Point (DSCP) value included in the packet's header. For example, the CBF override rule (fecA, DSCP=20)->cbfFec1 indicates that any ingress packet that is assigned the FEC named fecA (i.e., the overridden FEC) and belongs to the traffic class identified by DSCP value 20 should instead be assigned a different FEC named cbfFec1 (i.e., the overriding FEC).

One complication with implementing CBF in network device 100 is that the device may have configured thereon one or more parent FECs that each include multiple child FECs as mentioned in the previous section. In such a scenario, if a CBF override rule is configured in TCAM 120 that overrides a child FEC, packet processor 112 will not apply this child FEC CBF override rule to an ingress packet that is assigned a parent FEC including the child FEC, because that packet is never actually assigned the child FEC (it is only forwarded using the child FEC upon being assigned the parent FEC). This can result in “incorrect” forwarding decisions for ingress packets that are assigned the parent FEC, or, in other words, forwarding decisions that ignore the intent of the child FEC CBF override rule.

For example, assume network device 100 has configured thereon the parent FEC parentFecA=[childFecA, childFecB] in FEC table 116 and the child FEC CBF override rule (childFecA, DSCP=20)->cbfFec1 in TCAM 120. In this case, upon receiving an ingress packet that is assigned parentFecA, packet processor 112 will select either childFecA or childFecB and, assuming childFecA is selected, will forward the packet per the forwarding information associated with childFecA. This behavior is undesirable if the packet also has a DSCP value of 20 because the child FEC CBF override rule is intended to cause all ingress traffic that is matched to childFecA (and includes a DSCP value of 20) to be forwarded in accordance with cbfFec1 instead.

### 2. Solution Overview

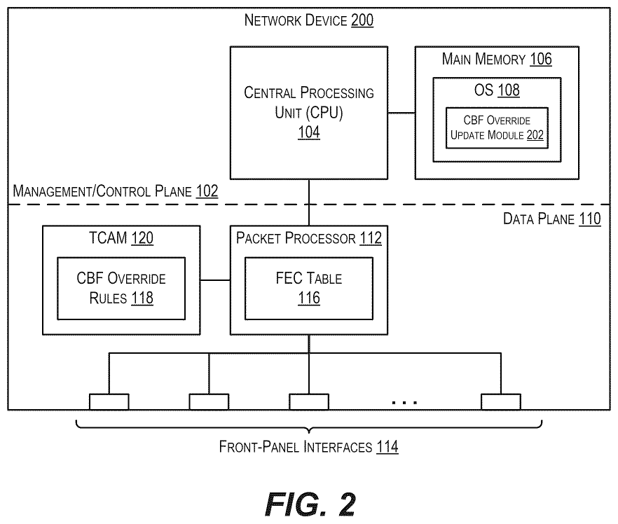

To address the foregoing and other similar problems, FIG. 2 depicts an enhanced version 200 of network device 100 of FIG. 1 that includes, within OS 108, a novel CBF override update module 202 according to certain embodiments. In these embodiments, module 202 is implemented in software (i.e., program code) that runs on CPU 104 from main memory 106.

At a high level, CBF override update module 202 is designed to (1) identify parent FECs in FEC table 116 that include child FECs overridden by child FEC CBF override rules, (2) configure new overriding parent FECs in FEC table 116 with respect to the identified parent FECs, and (3) configure new CBF override rules in TCAM 120 that override the identified parent FECs with the overriding parent FECs, based on the content of the child FEC CBF override rules. The result of steps (1)-(3) is that the overrides specified in the child FEC CBF override rules will be correctly enforced against ingress traffic that is assigned the original parent FECs (which include the overridden child FECs).

For example, consider a scenario where network device 200 has configured thereon the following initial set of parent FECs and CBF override rules:

### Parent FECs

parentFecA=[childFecA, childFecB]
parentFecB=[childFecA, childFecC]
parentFecC=[childFecD, childFecE]

### CBF Override Rules

(childFecA, DSCP=20)->cbfFec1
(childFecA, DSCP=21)->cbfFec2
(childFecB, DSCP=20)->cbfFec3
(childFecD, DSCP=30)->cbfFec4
(childFecE, DSCP=31)->cbfFec5

### Listing 2

In this scenario, CBF override update module 202 can generate the following new overriding parent FECs and new CBF override rules:

### New Overriding Parent FECs

parentFecA1=[cbfFec1, cbfFec3] (for DSCP=20)
parentFecA2=[cbfFec2, childFecB] (for DSCP=21)
parentFecB1=[cbfFec1, childFecC] (for DSCP=20)
parentFecB2=[cbfFec2, childFecC] (for DSCP=21)
parentFecC1=[cbfFec4, childFecE] (for DSCP=30)
parentFecC2=[childFecD, cbfFec5] (for DSCP=31)

### New CBF Override Rules

(parentFecA, DSCP=20)->parentFecA1
(parentFecA, DSCP=21)->parentFecA2
(parentFecB, DSCP=20)->parentFecB1
(parentFecB, DSCP=21)->parentFecB2
(parentFecC, DSCP=30)->parenfFecC1
(parentFecC, DSCP=31)->parentFecC2

### Listing 3

With this solution, the overrides specified in the original CBF override rules pertaining to childFecA, childFecB, childFecD, and childFecE will be correctly enforced in the context of the parent FECs that include these child FECs. For example, assume packet processor 112 of network device 200 receives an ingress packet with a destination address of D (which is mapped to parentFecA) and a DSCP value of 20. Without the new overriding parent FECs and new CBF override rules in Listing 2, packet processor 112 will assign parentFecA to the ingress packet and then forward the packet in accordance with one of the child FECs of parentFecA (i.e., childFecA or childFecB). This is incorrect because the CBF override rules indicate that any ingress packet matched to childFecA and including a DSCP value of 20 should be forwarded in accordance with cbfFec1, and any ingress packet matched to childFecB and including a DSCP value of 20 should be forwarded in accordance with cbfFec3.

However, with the new overriding parent FECs and new CBF override rules in Listing 2, packet processor 112 will assign parentFecA to the ingress packet, override (replace) this assignment with new overriding parentFecA1 per the first new CBF override rule above, and then forward the packet in accordance with one of the child FECs of parentFecA1 (i.e., cbfFec1 or cbfFec3). This is the correct and desired forwarding behavior for the ingress packet, per the original CBF override rules.

The remaining sections of the present disclosure describe various workflows for an example implementation of CBF override update module 202 that makes efficient use of FEC table 116, and more particularly can generate a solution that introduces the smallest possible number of new overriding parent FECs. This implementation is aware that (1) a child FEC can be overridden via multiple CBF override rules with different DSCP values, (2) a parent FEC can include multiple child FECs that are overridden in the context of the same DSCP value, and (3) a parent FEC can include multiple child FECs that are overridden in the context of different DSCP values.

It should be appreciated that FIGS. 1 and 2 and the foregoing high-level description are illustrative and not intended to limit embodiments of the present disclosure. For instance, although the example CBF override rules shown in Listings 2 and 3 above are based on DSCP values, the techniques of the present disclosure are equally applicable to CBF override rules that employ other types of override criteria, such as other packet header parameters.

Further, although FIGS. 1 and 2 depict a particular arrangement of components in network device 100/200, other arrangements are possible (e.g., the functionality attributed to a particular component may be split into multiple components, components may be combined, etc.). One of ordinary skill in the art will recognize other similar modifications, variations, and alternatives.

### 3. Startup Workflow

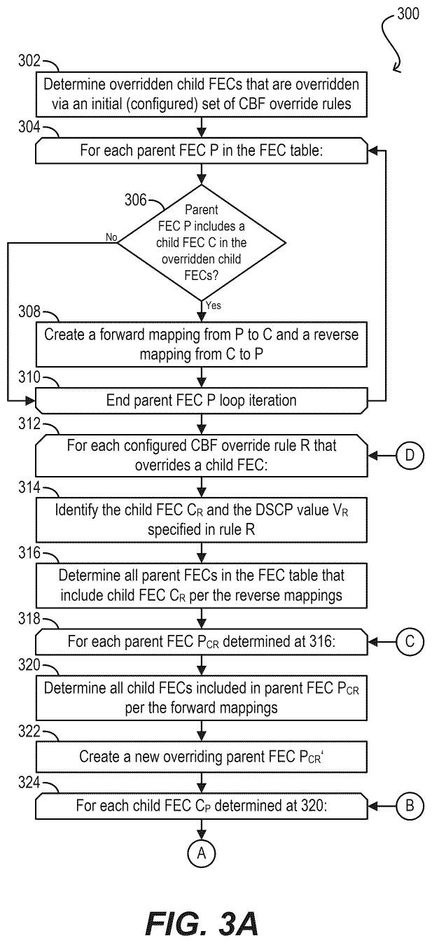

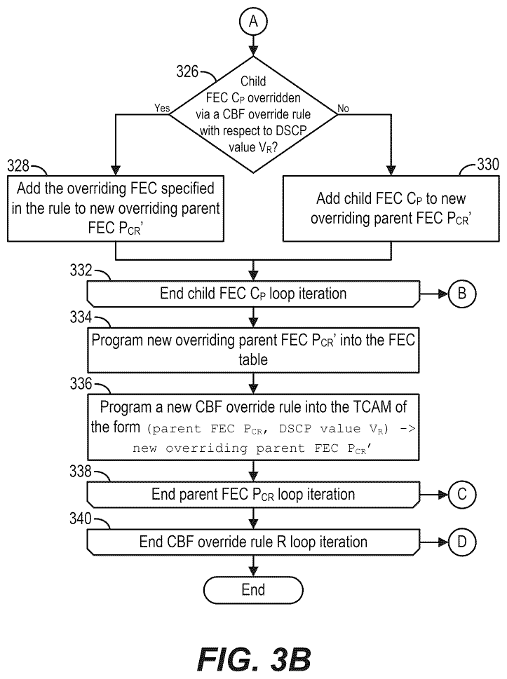

FIGS. 3A and 3B depict a workflow 300 that may be executed by CBF override update module 202 of network device 200 for generating new overriding parent FECs and new CBF override rules at startup of the network device according to certain embodiments. This workflow assumes that the network device's FEC table 116 has been populated with parent/child FECs and the network device has been configured with an initial set of CBF override rules.

Starting with step 302 of FIG. 3A, CBF override update module 202 can determine a set of overridden child FECs that are overridden via the configured CBF override rules. For example, with respect to Listing 2 presented previously, this set would include childFecA, childFecB, childFecD, and childFecE.

At step 304, CBF override update module 202 can enter a loop for each parent FEC P in FEC table 116. Within this loop, CBF override update module 202 can check whether parent FEC P includes a child FEC C that is in the set of overridden child FECs determined at step 302 (step 306). If so, CBF override update module 202 can create a first (forward) mapping from P to C and a second (reverse) mapping from C to P (step 308). CBF override update module 202 can then reach the end of the current loop iteration (step 310) and return to step 304 to process the next parent FEC.

Upon completing the first loop, CBF override update module 202 can enter a second loop at step 312 for each configured CBF override rule R that overrides a child FEC. Within this second loop, CBF override update module 202 can identify the child FEC C_{R} and the DSCP value V_{R} specified in rule R (step 314) and can determine all parent FECs in FEC table 116 that include child FEC C_{R} per the reverse mappings created at step 308 (step 316).

CBF override update module 202 can subsequently enter a third loop at step 318 for each parent FEC P_{CR} determined at step 316. Within this third loop, CBF override update module 202 can determine all child FECs included in parent FEC P_{CR} per the forward mappings created at step 308 (step 320), create a new overriding parent FEC P_{CR}′ (step 322), and enter a fourth loop for each child FEC C_{P} determined at step 320 (step 324).

Turning now to FIG. 3B, within the fourth loop, CBF override update module 202 can check whether child FEC C_{P} is overridden via a CBF override rule with respect to DSCP value V_{R} (step 326). If the answer is yes, CBF override update module 202 can add the overriding child FEC specified in that rule to new overriding parent FEC P_{CR}′ (step 328). Otherwise, CBF override update module 202 can add original child FEC C_{P} to new overriding parent FEC P_{CR}′ (step 330). CBF override update module 202 can then reach the end of the current loop iteration of the fourth loop (step 332) and return to step 324 to process the next child FEC in parent FEC P_{CR}.

Upon completing the fourth loop, CBF override update module 202 can program new overriding parent FEC P_{CR}′ into FEC table 116 (step 334). It should be noted that if original parent FEC P_{CR} previously had an overriding parent FEC programmed for it, step 334 can replace that FEC with P_{CR}′.

CBF override update module 202 can then program a new CBF override rule into TCAM 120 of the form (parent FEC P_{CR}, DSCP value V_{R})->new overriding parent FEC P_{CR}′ (step 336), reach the end of the current loop iteration of the third loop (step 338), and return to step 318 to process the next parent FEC determined at step 316.

Upon completing the third loop, CBF override update module 202 can reach the end of the current loop iteration of the second loop (step 340) and return to step 312 to process the next CBF override rule. Finally, upon completing the second loop, workflow 300 can end.

### 4. Parent FEC Update Workflow

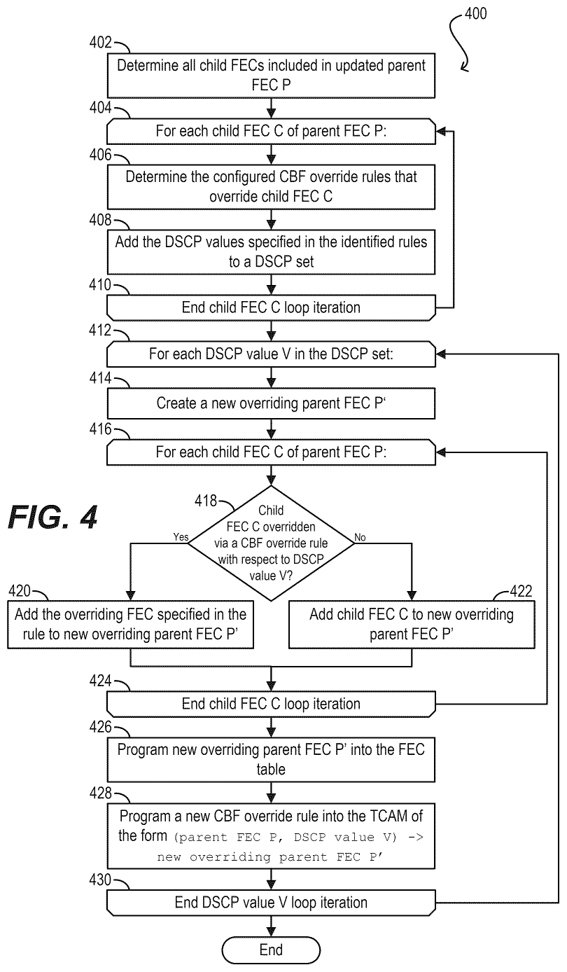

FIG. 4 depicts a workflow 400 that may be executed by CBF override update module 202 of network device 200 for generating new overriding parent FECs and new CBF override rules in response to an update to a parent FEC P in FEC table 116 according to certain embodiments.

Starting with steps 402 and 404, CBF override update module 202 can determine all child FECs included in parent FEC P and can enter a loop for each determined child FEC C.

Within this loop, CBF override update module 202 can determine the configured CBF override rules that override child FEC C (step 406) and can add the DSCP values specified in the identified rules to a DSCP set (step 408). CBF override update module 202 can then reach the end of the current loop iteration (step 410) and return to step 404 to process the next child FEC.

Upon completing the first loop, CBF override update module 202 can enter a second loop at step 412 for each DSCP value V in the DSCP set. Within this second loop, CBF override update module 202 can create a new overriding parent FEC P′ (step 414) and enter a third loop for each child FEC C of parent FEC P (step 416).

Within the third loop, CBF override update module 202 can check whether child FEC C is overridden via a CBF override rule with respect to DSCP value V (step 418). If the answer is yes, CBF override update module 202 can add the overriding FEC specified in that rule to new overriding parent FEC P′ (step 420). Otherwise, CBF override update module 202 can add original child FEC C to new overriding parent FEC P′ (step 422). CBF override update module 202 can then reach the end of the current loop iteration of the third loop (step 424) and return to step 416 to process the next child FEC in parent FEC P.

Upon completing the third loop, CBF override update module 202 can program new overriding parent FEC P′ into FEC table 116 (step 426). It should be noted that if original parent FEC P previously had an overriding parent FEC programmed for it, step 426 can replace that FEC with P′.

CBF override update module 202 can then program a new CBF override rule into TCAM 120 of the form (parent FEC P, DSCP value V)->new overriding parent FEC P′ (step 428), reach the end of the current loop iteration of the second loop (step 430), and return to step 412 to process the next DSCP value in the DSCP set. Finally, upon completing the second loop, workflow 400 can end.

### 5. CBF Override Rule Update Workflow

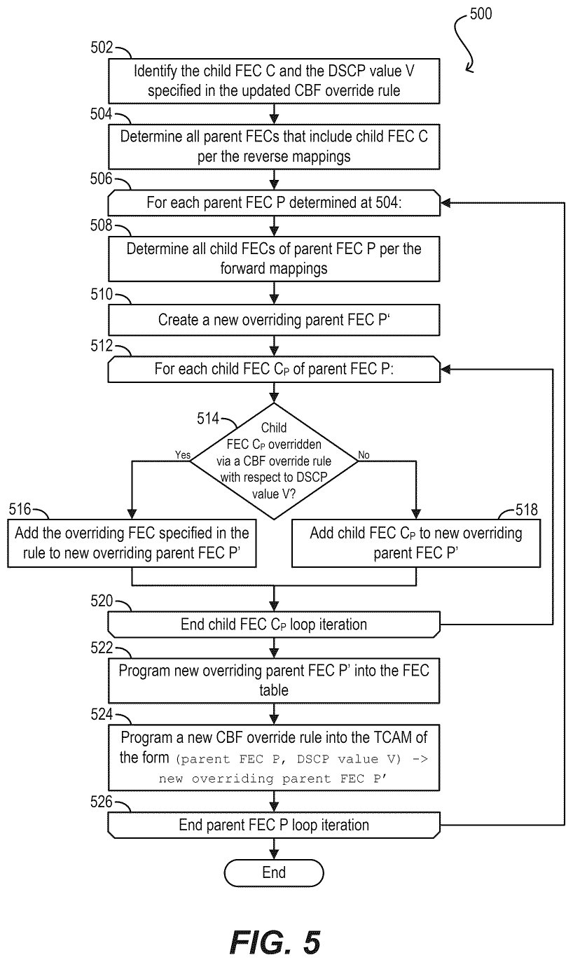

FIG. 5 depicts a workflow 500 that may be executed by CBF override update module 202 of FIG. 2 for generating new overriding parent FECs and new CBF override rules in response to an update to a configured CBF override rule according to certain embodiments.

Starting with steps 502 and 504, CBF override update module 202 can identify the child FEC C and the DSCP value V specified in the updated CBF override rule and can determine all parent FECs that include child FEC C per the reverse mappings created at step 308 of workflow 300.

At step 506, CBF override update module 202 can enter a loop for each parent FEC P determined at step 504. Within this loop, CBF override update module 202 can determine all child FECs included in parent FEC P per the forward mappings created at step 308 of workflow 300 (step 508) and create a new overriding parent FEC P′ (step 510). CBF override update module 202 can then enter a second loop for each child FEC C_{P} determined at step 508 (step 512).

Within the second loop, CBF override update module 202 can check whether child FEC C_{P} is overridden via a CBF override rule with respect to DSCP value V (step 514). If the answer is yes, CBF override update module 202 can add the overriding FEC specified in that rule to new overriding parent FEC P′ (step 516). Otherwise, CBF override update module 202 can add original child FEC C_{P} to new overriding parent FEC P′ (step 518). CBF override update module 202 can then reach the end of the current loop iteration of the second loop (step 520) and return to step 512 to process the next child FEC in parent FEC P.

Upon completing the second loop, CBF override update module 202 can program new overriding parent FEC P′ into FEC table 116 (step 522). It should be noted that if original parent FEC P previously had an overriding parent FEC programmed for it, step 522 can replace that FEC with P′.

CBF override update module 202 can then program a new CBF override rule into TCAM 120 of the form (parent FEC P, DSCP value V)->new overriding parent FEC P′ (step 524), reach the end of the current loop iteration of the first loop (step 526), and return to step 506 to process the next parent FEC. Finally, upon completing the first loop, workflow 500 can end.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device, the method comprising:
identifying one or more parent forwarding equivalence classes (FECs) configured in a FEC table of the network device, each of the one or more parent FECs including one or more child FECs that are overridden via a set of class-based forwarding (CBF) override rules;
configuring one or more new overriding parent FECs in the FEC table for the one or more parent FECs; and
configuring one or more new CBF override rules in a ternary content-addressable memory (TCAM) of the network device that override the one or more parent FECs with the one or more new overriding parent FECs, based on the set of CBF override rules.

2. The method of claim 1 wherein the identifying, the configuring of the one or more new overriding parent FECs, and the configuring of the one or more new CBF override rules comprises, at startup of the network device:
determining a set of overridden child FECs that are overridden via the set of CBF override rules;
for each parent FEC in the FEC table:
upon determining that the parent FEC has a child FEC in the set of overridden child FECs, creating a forward mapping from the parent FEC to the child FEC and a reverse mapping from the child FEC to the parent FEC.

3. The method of claim 2 wherein the identifying, the configuring of the one or more new overriding parent FECs, and the configuring of the one or more new CBF override rules further comprises, for each CBF override rule in the set of CBF override rules:
identifying a child FEC and a DSCP value specified in the CBF override rule; and
determining, using the reverse mappings, a set of parent FECs in the FEC table that each includes the child FEC.

4. The method of claim 3 wherein the identifying, the configuring of the one or more new overriding parent FECs, and the configuring of the one or more new CBF override rules further comprises, for each parent FEC in the set of parent FECs:
determining, using the forward mappings, a set of child FECs included in the parent FEC;
creating a new overriding parent FEC;
for each child FEC in the set of child FECs:
upon determining that the child FEC is overridden via a CBF override rule with respect to the DSCP value, adding an overriding FEC specified in the CBF override rule to the new overriding parent FEC; and
upon determining that the child FEC is not overridden via a CBF override rule with respect to the DSCP value, adding the child FEC to the new overriding parent FEC;
programming the new overriding parent FEC into the FEC table; and
programming a new CBF override rule into the TCAM that overrides the parent FEC with the new overriding parent FEC with respect to the DSCP value.

5. The method of claim 1 wherein the identifying, the configuring of the one or more new overriding parent FECs, and the configuring of the one or more new CBF override rules comprises, in response to an update to a parent FEC in the FEC table:
determining a set of child FECs included in the parent FEC; and
for each child FEC in the set of child FECs:
determining a subset of CBF override rules that override the child FEC; and
adding DSCP values specified in the subset of CBF override rules to a DSCP set.

6. The method of claim 5 wherein the identifying, the configuring of the one or more new overriding parent FECs, and the configuring of the one or more new CBF override rules further comprises, for each DSCP value in the DSCP set:
creating a new overriding parent FEC;
for each child FEC in the set of child FECs:
upon determining that the child FEC is overridden via a CBF override rule with respect to the DSCP value, adding an overriding FEC specified in the CBF override rule to the new overriding parent FEC; and
upon determining that the child FEC is not overridden via a CBF override rule with respect to the DSCP value, adding the child FEC to the new overriding parent FEC;
programming the new overriding parent FEC into the FEC table; and
programming a new CBF override rule into the TCAM that overrides the parent FEC with the new overriding parent FEC with respect to the DSCP value.

7. The method of claim 2 wherein the identifying, the configuring of the one or more new overriding parent FECs, and the configuring of the one or more new CBF override rules comprises, in response to an update to a CBF override rule:
identifying a child FEC and a DSCP value specified in the CBF override rule;
determining, using the reverse mappings, a set of parent FECs in the FEC table that each includes the child FEC; and
for each parent FEC in the set of parent FECs:
determining, using the forward mappings, a set of child FECs included in the parent FEC; and
creating a new overriding parent FEC.

8. The method of claim 7 wherein the identifying, the configuring of the one or more new overriding parent FECs, and the configuring of the one or more new CBF override rules further comprises, for each child FEC in the set of child FECs:
upon determining that the child FEC is overridden via a CBF override rule with respect to the DSCP value, adding an overriding FEC specified in the CBF override rule to the new overriding parent FEC; and
upon determining that the child FEC is not overridden via a CBF override rule with respect to the DSCP value, adding the child FEC to the new overriding parent FEC.

9. The method of claim 8 wherein the identifying, the configuring of the one or more new overriding parent FECs, and the configuring of the one or more new CBF override rules further comprises:
programming the new overriding parent FEC into the FEC table; and
programming a new CBF override rule into the TCAM that overrides the parent FEC with the new overriding parent FEC with respect to the DSCP value.

10. A network device comprising:
a central processing unit (CPU);
a forwarding equivalence class (FEC) table;
a ternary content-addressable memory (TCAM); and
a memory having stored thereon program code that, when executed by the CPU, causes the CPU to:
identify one or more parent forwarding equivalence classes (FECs) configured in the FEC table, each of the one or more parent FECs including one or more child FECs that are overridden via a set of class-based forwarding (CBF) override rules;
configure one or more new overriding parent FECs in the FEC table for the one or more parent FECs; and
configure one or more new CBF override rules in the TCAM that override the one or more parent FECs with the one or more new overriding parent FECs, based on the set of CBF override rules.

11. The network device of claim 10 wherein the program code that causes the CPU to perform the identifying, the configuring of the one or more new overriding parent FECs, and the configuring of the one or more new CBF override rules comprises program code that causes the CPU to, at startup of the network device:
determine a set of overridden child FECs that are overridden via the set of CBF override rules;
for each parent FEC in the FEC table:
upon determining that the parent FEC has a child FEC in the set of overridden child FECs, create a forward mapping from the parent FEC to the child FEC and a reverse mapping from the child FEC to the parent FEC.

12. The network device of claim 11 wherein the program code that causes the CPU to perform the identifying, the configuring of the one or more new overriding parent FECs, and the configuring of the one or more new CBF override rules further comprises program code that causes the CPU to, for each CBF override rule in the set of CBF override rules:
identify a child FEC and a DSCP value specified in the CBF override rule; and
determine, using the reverse mappings, a set of parent FECs in the FEC table that each includes the child FEC.

13. The network device of claim 12 wherein the program code that causes the CPU to perform the identifying, the configuring of the one or more new overriding parent FECs, and the configuring of the one or more new CBF override rules further comprises program code that causes the CPU to, for each parent FEC in the set of parent FECs:
determine, using the forward mappings, a set of child FECs included in the parent FEC;
create a new overriding parent FEC;
for each child FEC in the set of child FECs:
upon determining that the child FEC is overridden via a CBF override rule with respect to the DSCP value, add an overriding FEC specified in the CBF override rule to the new overriding parent FEC; and
upon determining that the child FEC is not overridden via a CBF override rule with respect to the DSCP value, add the child FEC to the new overriding parent FEC;
program the new overriding parent FEC into the FEC table; and
program a new CBF override rule into the TCAM that overrides the parent FEC with the new overriding parent FEC with respect to the DSCP value.

14. The network device of claim 10 wherein the program code that causes the CPU to perform the identifying, the configuring of the one or more new overriding parent FECs, and the configuring of the one or more new CBF override rules comprises program code that causes the CPU to, in response to an update to a parent FEC in the FEC table:
determine a set of child FECs included in the parent FEC; and
for each child FEC in the set of child FECs:
determine a subset of CBF override rules that override the child FEC; and
add DSCP values specified in the subset of CBF override rules to a DSCP set.

15. The network device of claim 14 wherein the program code that causes the CPU to perform the identifying, the configuring of the one or more new overriding parent FECs, and the configuring of the one or more new CBF override rules further comprises program code that causes the CPU to, for each DSCP value in the DSCP set:
create a new overriding parent FEC;
for each child FEC in the set of child FECs:
upon determining that the child FEC is overridden via a CBF override rule with respect to the DSCP value, add an overriding FEC specified in the CBF override rule to the new overriding parent FEC; and
upon determining that the child FEC is not overridden via a CBF override rule with respect to the DSCP value, add the child FEC to the new overriding parent FEC;
program the new overriding parent FEC into the FEC table; and
program a new CBF override rule into the TCAM that overrides the parent FEC with the new overriding parent FEC with respect to the DSCP value.

16. The network device of claim 11 wherein the program code that causes the CPU to perform the identifying, the configuring of the one or more new overriding parent FECs, and the configuring of the one or more new CBF override rules comprises program code that causes the CPU to, in response to an update to a CBF override rule:
identify a child FEC and a DSCP value specified in the CBF override rule;
determine, using the reverse mappings, a set of parent FECs in the FEC table that each includes the child FEC; and
for each parent FEC in the set of parent FECs:
determine, using the forward mappings, a set of child FECs included in the parent FEC; and
create a new overriding parent FEC.

17. The network device of claim 16 wherein the program code that causes the CPU to perform the identifying, the configuring of the one or more new overriding parent FECs, and the configuring of the one or more new CBF override rules further comprises program code that causes the CPU to, for each child FEC in the set of child FECs:
upon determining that the child FEC is overridden via a CBF override rule with respect to the DSCP value, add an overriding FEC specified in the CBF override rule to the new overriding parent FEC; and
upon determining that the child FEC is not overridden via a CBF override rule with respect to the DSCP value, add the child FEC to the new overriding parent FEC.

18. The network device of claim 17 wherein the program code that causes the CPU to perform the identifying, the configuring of the one or more new overriding parent FECs, and the configuring of the one or more new CBF override rules further comprises program code that causes the CPU to:
program the new overriding parent FEC into the FEC table; and
program a new CBF override rule into the TCAM that overrides the parent FEC with the new overriding parent FEC with respect to the DSCP value.

19. A method performed by a network device, the method comprising:
identifying one or more parent forwarding equivalence classes (FECs) configured on the network device, each of the one or more parent FECs including one or more child FECs that are overridden via a set of class-based forwarding (CBF) override rules;
configuring one or more new overriding parent FECs on the network device for the one or more parent FECs; and
configuring one or more new CBF override rules on the network device that override the one or more parent FECs with the one or more new overriding parent FECs.

20. The method of claim 19 wherein the one or more new CBF override rules override the one or more parent FECs with the one or more new overriding parent FECs based on contents of the set of CBF override rules.
